(19) United States
(12) Patent Application Publication
(10) Pub. No.: US 2018/0037114 A1
(43) Pub. Date: Feb. 8, 2018

(54) SMART KEY DEVICES AND METHODS

(71) Applicant: MasterCard International Incorporated, Purchase, NY (US)

(72) Inventor: Arunmurthy Gurunathan, Pune (IN)

(21) Appl. No.: 15/638,908

(22) Filed: Jun. 30, 2017

(30) Foreign Application Priority Data
Aug. 4, 2016 (SG) 10201606448T

(51) Int. Cl. B60K 31/00; G06Q 20/34; B60R 25/24

(52) U.S. Cl. CPC B60K 31/0058; B60R 25/24; G06Q 20/34; B60R 2325/108; B60R 2325/40; B60K 2031/0091; B60Y 2302/05; B60Y 2302/07

(57) ABSTRACT

A smart key device for use with a vehicle is disclosed. The smart key comprises: an interface configured to communicatively couple with a controller of the vehicle; and a non-volatile storage module configured to store a deactivation message configured to cause the controller of the vehicle to deactivate and/or limit the functionality of the vehicle. The deactivation message may include an indication of a time period or distance driven after which the vehicle will be deactivated. A vehicle controller; a smart key write device and associated methods are also disclosed.

### CROSS-REFERENCE TO RELATED APPLICATION

This application is a U.S. National Stage filing under 35 U.S.C. § 119, based on and claiming benefit of and priority to SG Patent Application No. 10201606448T filed Aug. 4, 2016.

### TECHNICAL FIELD AND BACKGROUND

The present disclosure relates to smart key devices for vehicles.

In many countries there is a requirement for drivers to have certain documents such as a driving license, registration documents for the vehicle and proof of insurance. If a driver is stopped by the police they may be required to show these documents. If the driver does not have the required documents with them, then they may be required to present the documents at a police station within a certain period of time. However, there is no way of the police ensuring that the driver complies with this.

If a driver is stopped due to an offense and required to pay a fine, there can be difficulties enforcing the fine if the driver is no able to pay on the spot. It may not be possible for the police to confiscate the vehicle and the vehicle may cause a hazard if it is left on the roadside. However if the driver is allowed to leave then there may be difficulties in enforcing the fine.

### SUMMARY

In general terms, the present disclosure proposes a smart key device which can be restricted by the police to drive only for certain time or distance. The smart key device carries a deactivation message which when read by a controller in the corresponding vehicle limits the time or distance that the vehicle may be driven until a reactivation message is added. The deactivation message may be added in case of invalid documents. The reactivation message may be added, for example, once the driven has provided the necessary documents or paid a fine. The smart key device may also be used as a payment device. The smart key device may be loaded with money for payments related to car expense or during travel.

According to a first aspect of the present invention, there is provided a smart key device for use with a vehicle. The smart key device comprises: an interface configured to communicatively couple with a controller of the vehicle; and a non-volatile storage module configured to store a deactivation message configured to cause the controller of the vehicle to deactivate the vehicle and/or to limit the functionality of the vehicle.

In some embodiments, the deactivation message comprises a time period indication and the deactivation message is configured to cause the controller of the vehicle to deactivate the vehicle on expiry of the time period.

In some embodiments, the deactivation message comprises a distance limit indication and the deactivation message is configured to cause the controller of the vehicle to deactivate the vehicle when a distance travelled by the vehicle after receiving the deactivation message reaches the distance limit.

In some embodiments, the deactivation message comprises a vehicle functionality limitation indication and the deactivation message is configured to cause the controller of the vehicle to limit the functionality of the vehicle according to the vehicle functionality limitation indication. The functionality limitation may be a speed limitation.

In some embodiments, the deactivation message is encrypted to control read and/or write access.

The non-volatile storage module may be further configured to store an event history comprising indications of events and/or offenses and/or endorsements and/or fines paid in relation to the vehicle.

In some embodiment, the non-volatile storage further comprises an indication of a payment card account. The non-volatile storage may comprise an indication of a balance associated with the payment card account.

According to a second aspect of the present invention there is provided a controller for a vehicle. The controller comprises: an interface configured to read a deactivation message stored on a smart key device; and a deactivation module configured to deactivate and/or to limit the functionality of the vehicle in response to the deactivation message.

In some embodiments, the deactivation message comprises a time period indication and the deactivation module is configured to deactivate the vehicle on expiry of the time period.

In some embodiments, the deactivation message comprises a distance limit indication and the deactivation module is configured to deactivate the vehicle when a distance travelled by the vehicle after receiving the deactivation message reaches the distance limit.

In some embodiments, the deactivation message comprises a vehicle functionality limitation indication and the deactivation message is configured to cause the controller of the vehicle to limit the functionality of the vehicle according to the vehicle functionality limitation indication. The functionality limitation may be a speed limitation.

In some embodiments, the controller further comprises a smart key synchronization memory configured to store key data read from a first smart key device and wherein the interface is further configured to write the key data in a memory of a second smart key device. The key data may comprise an event history comprising indications of events and/or offenses and/or endorsements and/or fines paid in relation to the vehicle.

According to a third aspect of the present invention there is provided a method in a controller for a vehicle. The method comprises: reading a deactivation message stored on a smart key device; and deactivating and/or limiting the functionality of the vehicle in response to the deactivation message.

In some embodiments, the deactivation message comprises a time period indication and deactivating the vehicle in response to the deactivation message comprises deactivating the vehicle on expiry of the time period.

In some embodiments, the deactivation message comprises a distance limit indication and deactivating the vehicle in response to the deactivation message comprises deactivating the vehicle when a distance travelled by the vehicle after reading the deactivation message reaches the distance limit.

In some embodiments, the deactivation message comprises a vehicle functionality limitation indication. The functionality limitation may be a speed limitation.

In some embodiments the method further comprises reading key data from a first smart key device; storing the key data on a synchronization memory of the controller and writing the key data in a memory of a second smart key device. The key data may comprise an event history comprising indications of events and/or offenses and/or endorsements and/or fines paid in relation to the vehicle.

According to a fourth aspect of the present invention there is provided a smart key write device comprising a smart key interface configured to write a deactivation message in a non-volatile storage of a smart key device, the deactivation message configured to cause a controller of a vehicle to deactivate and/or limit the functionality of the vehicle.

In some embodiments, the deactivation message comprises a time period indication and the deactivation message is configured to cause the controller of the vehicle to deactivate the vehicle on expiry of the time period.

In some embodiments, the deactivation message comprises a distance limit indication and the deactivation message is configured to cause the controller of the vehicle to deactivate the vehicle when a distance travelled by the vehicle after receiving the deactivation message reaches the distance limit.

In some embodiments, the deactivation message comprises a vehicle functionality limitation indication. The functionality limitation may be a speed limitation.

According to a fifth aspect of the present invention there is provided a method in a smart key write device, the method comprising: writing a deactivation message in a non-volatile storage of a smart key device, the deactivation message configured to cause a controller of a vehicle to deactivate and/or limit the functionality of the vehicle.

In some embodiments, the deactivation message comprises a time period indication and the deactivation message is configured to cause the controller of the vehicle to deactivate the vehicle on expiry of the time period.

In some embodiments, the deactivation message comprises a distance limit indication and the deactivation message is configured to cause the controller of the vehicle to deactivate the vehicle when a distance travelled by the vehicle after receiving the deactivation message reaches the distance limit.

In some embodiments, the deactivation message comprises a vehicle functionality limitation indication. The functionality limitation may be a speed limitation

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram showing a smart key device according to an embodiment of the present invention;

FIG. 2 is a block diagram showing a vehicle controller according to an embodiment of the present invention;

FIG. 3 is a block diagram showing a smart key write device according to an embodiment of the present invention;

FIG. 4 is a flowchart showing a method in a controller of a vehicle according to an embodiment of the present invention;

FIG. 5 is a flowchart showing a method in a controller of a vehicle portal according to an embodiment of the present invention; and

FIG. 6 is a flowchart showing a method in a smart key write device according to an embodiment of the present invention.

### DETAILED DESCRIPTION

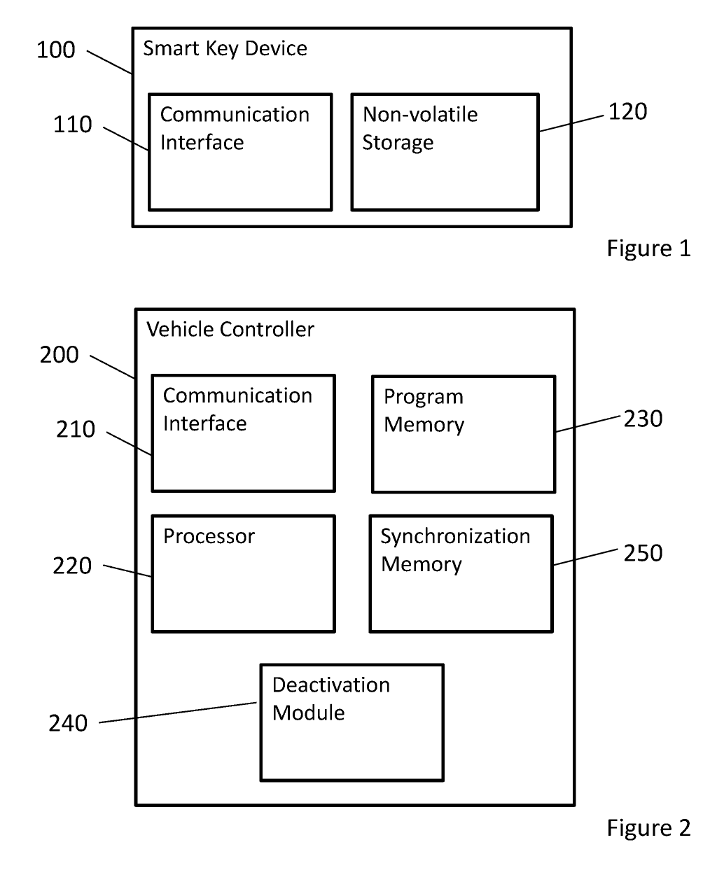

FIG. 1 is a block diagram showing a smart key device 100 according to an embodiment of the present invention. The smart key device 100 comprises a communication interface 110 and a non-volatile storage 120. The smart key device 100 can be used to access and activate a vehicle such as a car. The smart key device 100 may be operable to unlock the doors of a car to allow access and also to activate the car to allow the engine to start.

The communication interface 110 of the smart key device 100 allows the smart key device 100 to communicate with a controller of a vehicle. An embodiment of the controller for a vehicle is described in more detail below with reference to FIG. 2. The communication interface 110 may be a contactless communication interface. In some embodiments, communication between the smart key device 100 and the controller of the vehicle may be activated by pressing a button on the smart key device 100. In other embodiments, communication may be activated by proximity to the controller. For example, the smart key device 100 may activate communication with the controller when it comes within a certain distance of the controller or alternatively when it is placed in a certain position relative to the controller.

The non-volatile storage 120 of the smart key device 100 is configured to store a deactivation message. The deactivation message may be added by, for example, the police if the driver of the vehicle is required to provide documents or pay a fine. The deactivation message may include a time period indication. This time period indication limits the time for which the vehicle can be driven until it is deactivated. This time period may be for example 14 days in which the requirements must be met, for example, provision of the documents or payment of the fine. Alternatively, the period may be shorter, for example, 3 hours to allow the vehicle to be driven to a safe location. Alternatively, the deactivation message may include an indication of a distance that the vehicle can be driven until it is deactivated. This distance may be for example 50 km in order to allow the vehicle to be driven to a safe location.

In an embodiment, the deactivation message comprises a vehicle functionality limitation indication. In such embodiments, the vehicle functionality limitation indication limits a functionality of the vehicle. For example, the speed at which the vehicle can be driven may be limited to, for example 20 MPH or 30 MPH. The inclusion of such a vehicle functionality limitation would prevent the vehicle from being abruptly stopped in a location that would cause problems for other drivers such as on highway or a bridge or in a tunnel. The deactivation message may include an indication of the speed limitation for the vehicle.

The non-volatile storage 120 may be encrypted to prevent unauthorised access and/or modification. The communication interface 110 may be configured to communicate through a communication protocol such as near field communications (NFC) or radio frequency identity (RFID) communications.

The non-volatile storage 120 of the smart key device 100 may store a smart key identifier such as an identification number. This identifier is used by a controller of the vehicle to determine whether the smart key device 100 is authorized for use with the vehicle.

In addition to storing a deactivation message, the non-volatile storage 120 may also store additional information. This additional information may be history information for the vehicle or the driver of the vehicle. This history information may include, for example, the service history of the vehicle; details of certification tests carried out on the vehicle such as emissions or pollution tests; details of any accidents that the vehicle has been involved in; details of insurance policies for the vehicle; or details of any fines paid by the driver.

The smart key device 100 may also function as a payment card. Thus, the non-volatile storage 120 may store an identifier of a payment card account, or the non-volatile storage may allow a credit balance to be loaded onto the smart key device 100. Thus the smart key device 100 may be loaded with money for payments related to car expense or during travel. Additionally, the smart key device may be used as an identifier and scanned and used to calculate time between entry and exit then pay for parking.

FIG. 2 is a block diagram showing a vehicle controller 200 according to an embodiment of the present invention. The vehicle controller 200 may be located in the dashboard of a car. The vehicle controller 200 comprises a communication interface 210; a processor 220 a program memory 230; a deactivation module 240 and a synchronization memory 240. The processor 210 (which may be referred to as a central processor unit or CPU) is in communication with the program memory 230.

The program memory 230 may be implemented as a solid state storage device or one or more disk drives and is used for non-volatile storage of data. The program memory 230 may be used to store programs which are loaded into a random access memory (RAM) when such programs are selected for execution. The program memory 230 comprises non-transitory instructions operative by the processor 220 to perform various operations of the method of the present disclosure.

The communication interface 210 allows the vehicle controller 200 to communicate with a smart key device such as the smart key device 100 shown in FIG. 1. As discussed above, the communication interface 210 may be configured to communicate through a communication protocol such as near field communications (NFC) or radio frequency identity (RFID) communications. The vehicle controller 200 may store a list of valid/assigned smart key devices which are authorized for use with the vehicle and be configured to check whether a smart key device is authorized for use with the vehicle by checking an identifier of the smart key device matches one of the valid/assigned smart key devices.

The synchronisation memory 250 is a non-volatile storage device that allows the vehicle controller 200 to store information stored on one smart key device and synchronise that information with another smart key device.

The processor 210 executes instructions, codes, computer programs, scripts which it accesses from the program memory 230, or storage such as a flash drive, read only memory (ROM). While only one processor 210 is shown, multiple processors may be present. Thus, while instructions may be discussed as executed by a processor, the instructions may be executed simultaneously, serially, or otherwise executed by one or multiple processors.

The deactivation module 240 is coupled to the engine or ignition of the vehicle and is operable to deactivate or activate the vehicle under the control of the processor 220. Alternatively, or additionally, the deactivation module 240 may be configured to limit the functionality of the vehicle, for example by limiting the speed of the vehicle.

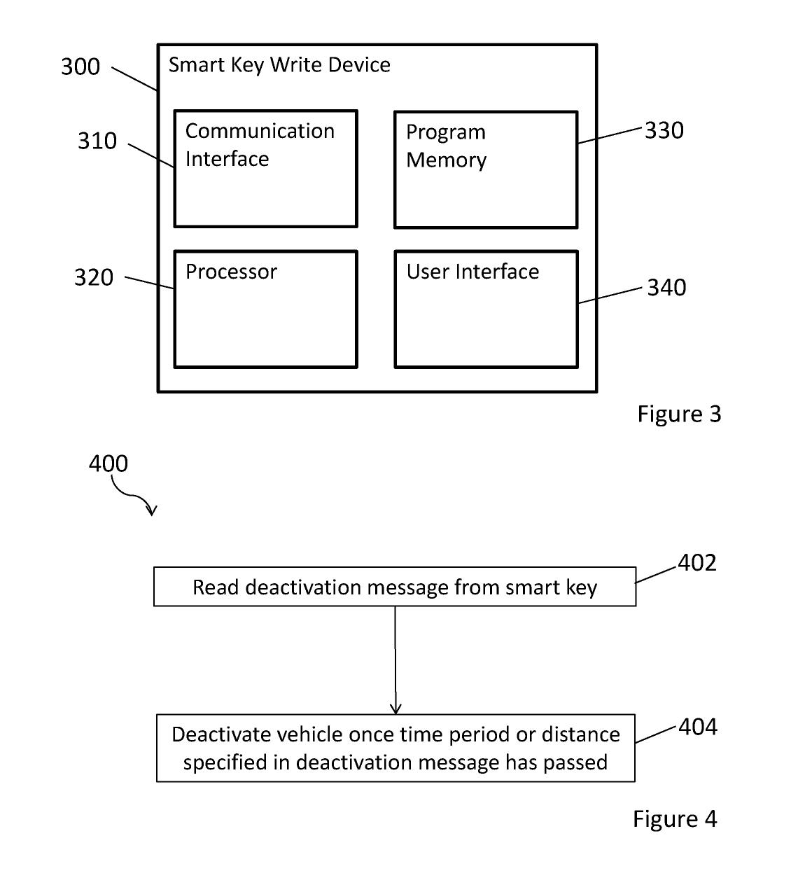

FIG. 3 is a block diagram showing a smart key write device 300 according to an embodiment of the present invention. The smart key write device 300 may be used to modify the data stored in the non-volatile storage 120 of the smart key device 100. The smart key write device 300 may be used by the police to add a deactivation message to the smart key device, it may also be used by an organization that services vehicles or provides insurance to update details stored on the non-volatile storage 120 of the smart key device 100.

The smart key write device 300 comprises a communication interface 310; a processor 320 a program memory 330; and a user interface 340. The processor 310 (which may be referred to as a central processor unit or CPU) is in communication with the program memory 330.

The program memory 330 may be implemented as a solid state storage device or one or more disk drives and is used for non-volatile storage of data. The program memory 330 may be used to store programs which are loaded into a random access memory (RAM) when such programs are selected for execution. The program memory 330 comprises non-transitory instructions operative by the processor 320 to perform various operations of the method of the present disclosure.

The communication interface 310 allows the smart key write device 300 to communicate with a smart key device such as the smart key device 100 shown in FIG. 1. As discussed above, the communication interface 310 may be configured to communicate through a communication protocol such as near field communications (NFC) or radio frequency identity (RFID) communications.

The user interface 340 allows a user to input information and commands to control the data sent to the smart key device 100 via the communication interface 310. The user interface may be implemented as a touch screen, a key pad or other device that allows a user to input data and commands.

The processor 310 executes instructions, codes, computer programs, scripts which it accesses from the program memory 330, or storage such as a flash drive, read only memory (ROM). While only one processor 310 is shown, multiple processors may be present. Thus, while instructions may be discussed as executed by a processor, the instructions may be executed simultaneously, serially, or otherwise executed by one or multiple processors.

Various operations of an exemplary method 400 will now be described with reference to FIG. 4 in controlling the deactivation of a vehicle. It should be noted that enumeration of operations is for purposes of clarity and that the operations need not be performed in the order implied by the enumeration. The method 400 shown in FIG. 4 is carried out by the vehicle controller 200 shown in FIG. 2 and involves a deactivation message read from a smart key device 100 as shown in FIG. 1.

In step 402, vehicle controller 200 reads the deactivation message from the smart key device 100. This may involve the communication interface 210 of the vehicle controller 200 communicating with the communication interface 110 of the smart key device 100. The vehicle controller 200 may validate a smart key identifier of the smart key device 100 and only allow specific smart key devices to update the deactivation message.

As described above, the non-volatile storage 120 of the smart key device 100 stores a deactivation message. The deactivation message may include an indication of a time period or distance after which the vehicle is to be deactivated.

In step 404, the vehicle controller 200 causes the vehicle to be deactivated. This step may involve the processor 220 causing the deactivation module 240 of the vehicle controller 200 to deactivate the vehicle. If the deactivation message includes a time period or distance after which the vehicle is to be deactivated, the vehicle controller 200 may store an indication of a remaining time or distance until the vehicle is deactivated and when this remaining time or distance reaches zero, the vehicle is deactivated.

As mentioned above, in some embodiments, the deactivation message comprises a vehicle functionality limitation indication. In such embodiments, in step 404, the controller causes the functionality of the vehicle to be limited. This limitation of functionality may be a limitation of the speed at which the vehicle can be driven. The speed limitation may be specified by the deactivation message.

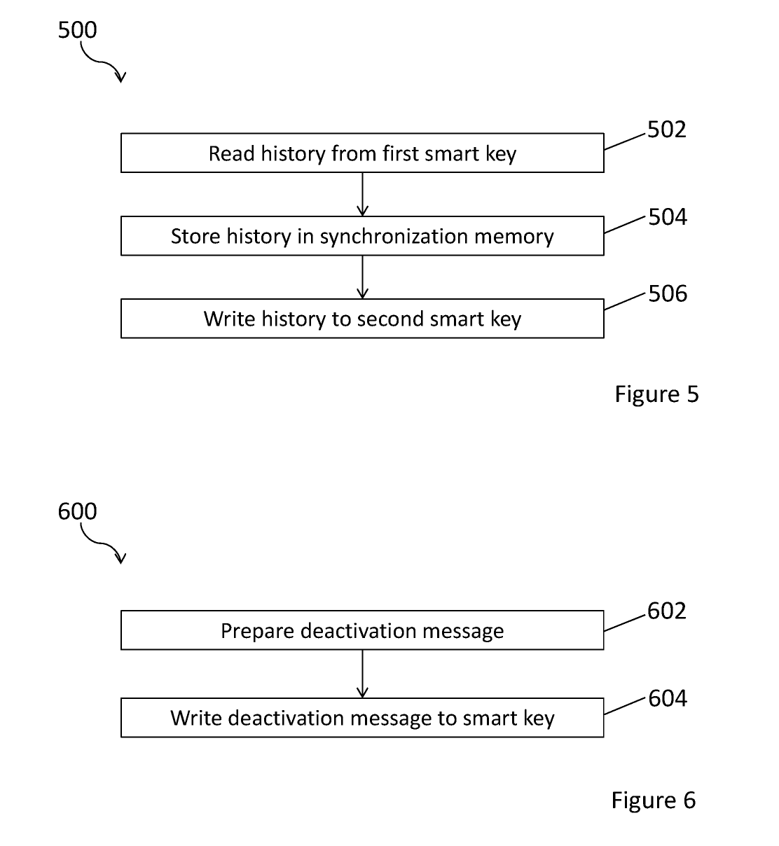

FIG. 5 is a flowchart showing a method of synchronizing information between smart key devices by the vehicle controller 200 shown in FIG. 2. It is envisaged that there may be more than one smart key device associated with a vehicle. In such a situation, the method 500 shown in FIG. 5 allows the information stored on first and second smart keys to be synchronized.

In step 502, history data is read from a first smart key device by the vehicle controller 200. As discussed above, the history data may include information on the service history of a vehicle or information insurance cover associated with the vehicle or details of accidents in which the vehicle has been involved.

In step 504, history data is stored in the synchronization memory 250 of the vehicle controller 200. The synchronization memory 250 may also store details of deactivation messages read from the first smart key.

In step 506, the history data is stored on a second smart key. Step 506 may occur when the second smart key comes into communicative contact with the vehicle controller 200. Thus, each time a smart key comes into communicative contact with the vehicle controller 200 a check may be carried out on whether the there is any data stored in the synchronization memory 250 which is not stored in the non-volatile memory of the smart key device.

FIG. 6 is a flowchart showing a method of writing a deactivation message to a smart key device. The method 600 is carried out by a smart key write device 300 as shown in FIG. 3.

In step 602, the smart key write device 300 prepares a deactivation message. This may involve a police officer using the user interface 340 to input details of a period or distance after which the vehicle should be deactivated.

In an embodiment, step 602 comprises preparing a deactivation message which indicates a vehicle functionality limitation such as a speed limitation.

In step 604, the smart key write device 300 writes the deactivation message to the smart key device 100. This may involve the communication interface 310 of the smart key write device 300 sending the deactivation message to the communication interface 110 of the smart key device 100 and the deactivation message being stored on the non-volatile storage 120 of the smart key device.

The smart key write device 300 may also be operable to write other messages or data onto the smart key device 100. For example, the smart key write device may be operable to write an activation message on the smart key device 100. Additionally, the smart key write device may be operable to write history data onto the smart key device 100.

Whilst the foregoing description has described exemplary embodiments, it will be understood by those skilled in the art that many variations of the embodiment can be made within the scope and spirit of the present invention.

1. A smart key device for use with a vehicle, the device comprising:
an interface configured to communicatively couple with a controller of the vehicle; and
a non-volatile storage module configured to store a deactivation message configured to cause the controller of the vehicle to deactivate and/or limit the functionality of the vehicle.

2. A smart key device according to claim 1 wherein the deactivation message comprises a time period indication and the deactivation message is configured to cause the controller of the vehicle to deactivate the vehicle on expiry of the time period.

3. A smart key device according to claim 1 wherein the deactivation message comprises a distance limit indication and the deactivation message is configured to cause the controller of the vehicle to deactivate the vehicle when a distance travelled by the vehicle after receiving the deactivation message reaches the distance limit.

4. A smart key device according to claim 1, wherein the deactivation message comprises a vehicle functionality limitation indication and the deactivation message is configured to cause the controller of the vehicle to limit the functionality of the vehicle according to the vehicle functionality limitation indication.

5. A smart key device according to claim 4, wherein the vehicle functionality limitation indication indicates a speed limitation.

6. A smart key device according to claim 1 wherein the deactivation message is encrypted to control read and/or write access.

7. A smart key device according to claim 1, wherein the non-volatile storage module is further configured to store an event history comprising indications of events and/or offenses and/or endorsements and/or fines paid in relation to the vehicle.

8. A smart key device according to claim 1, wherein the non-volatile storage further comprises an indication of a payment card account.

9. A smart key device according to claim 8, wherein the non-volatile storage further comprises an indication of a balance associated with the payment card account.

10. A controller for a vehicle, the controller comprising:
an interface configured to read a deactivation message stored on a smart key device; and
a deactivation module configured to deactivate and/or limit the functionality of the vehicle in response to the deactivation message.

11. A controller according to claim 10, wherein the deactivation message comprises a time period indication and the deactivation module is configured to deactivate the vehicle on expiry of the time period.

12. A controller according to claim 10, wherein the deactivation message comprises a distance limit indication and the deactivation module is configured to deactivate the vehicle when a distance travelled by the vehicle after receiving the deactivation message reaches the distance limit.

13. A controller according to claim 10, wherein the deactivation message comprises a vehicle functionality limitation indication and the deactivation module is configured to limit the functionality of the vehicle according to the vehicle functionality limitation indication.

14. A controller according to claim 13, wherein the vehicle functionality limitation indication indicates a speed limitation.

15. A controller according to claim 10, further comprising a smart key synchronization memory configured to store key data read from a first smart key device and wherein the interface is further configured to write the key data in a memory of a second smart key device.

16. A controller according to claim 15 wherein the key data comprises an event history comprising indications of events and/or offenses and/or endorsements and/or fines paid in relation to the vehicle.

17. A method in a controller for a vehicle, the method comprising:
reading a deactivation message stored on a smart key device; and
deactivating and/or limiting the functionality of the vehicle in response to the deactivation message.

18. A method according to claim 17, wherein the deactivation message comprises a time period indication and deactivating and/or limiting the functionality of the vehicle in response to the deactivation message comprises deactivating the vehicle on expiry of the time period.

19. A method according to claim 17, wherein the deactivation message comprises a distance limit indication and deactivating and/or limiting the functionality of the vehicle in response to the deactivation message comprises deactivating the vehicle when a distance travelled by the vehicle after reading the deactivation message reaches the distance limit.

20. A method according to claim 17, wherein the deactivation message comprises a vehicle functionality limitation indication and deactivating and/or limiting the functionality of the vehicle in response to the deactivation message comprises limiting the functionality of the vehicle according to the vehicle functionality limitation indication.

21. A smart key device according to claim 20, wherein the vehicle functionality limitation indication indicates a speed limitation.

22. A method according to claim 17, further comprising reading key data from a first smart key device; storing the key data on a synchronization memory of the controller and writing the key data in a memory of a second smart key device.

23. A method according to claim 22 wherein the key data comprises an event history comprising indications of events and/or offenses and/or endorsements and/or fines paid in relation to the vehicle.

24. A smart key write device comprising a smart key interface configured to write a deactivation message in a non-volatile storage of a smart key device, the deactivation message configured to cause a controller of a vehicle to deactivate and/or limit the functionality of the vehicle.

25. A smart key write device according to claim 24 wherein the deactivation message comprises a time period indication and the deactivation message is configured to cause the controller of the vehicle to deactivate the vehicle on expiry of the time period.

26. A smart key write device according to claim 24 wherein the deactivation message comprises a distance limit indication and the deactivation message is configured to cause the controller of the vehicle to deactivate the vehicle when a distance travelled by the vehicle after receiving the deactivation message reaches the distance limit.

27. A smart key write device according to claim 24, wherein the deactivation message comprises a vehicle functionality limitation indication and the deactivation message is configured to cause the controller of the vehicle to limit the functionality of the vehicle according to the vehicle functionality limitation indication.

28. A smart key write device according to claim 27, wherein the vehicle functionality limitation indication indicates a speed limitation.

29. A method in a smart key write device, the method comprising:
writing a deactivation message in a non-volatile storage of a smart key device, the deactivation message configured to cause a controller of a vehicle to deactivate and/or limit the functionality of the vehicle.

30. A method according to claim 29 wherein the deactivation message comprises a time period indication and the deactivation message is configured to cause the controller of the vehicle to deactivate the vehicle on expiry of the time period.

31. A method according to claim 29 wherein the deactivation message comprises a distance limit indication and the deactivation message is configured to cause the controller of the vehicle to deactivate the vehicle when a distance travelled by the vehicle after receiving the deactivation message reaches the distance limit.

32. A method according to claim 29 wherein the deactivation message comprises a vehicle functionality limitation indication and the deactivation message is configured to cause the controller of the vehicle to limit the functionality of the vehicle according to the vehicle functionality limitation indication.

33. A method according to claim 32 wherein the vehicle functionality limitation indication indicates a speed limitation.
